(19) United States
(12) Patent Application Publication
(10) Pub. No.: US 2024/0097203 A1
(43) Pub. Date: Mar. 21, 2024

(54) ELECTROLYTE SOLUTION FOR AQUEOUS ZINC BATTERY AND AQUEOUS ZINC BATTERY

(71) Applicant: KOREA ADVANCED INSTITUTE OF SCIENCE AND TECHNOLOGY, Daejeon (KR)

(72) Inventors: Hye Ryung BYON, Daejeon (KR); Moony NA, Daejeon (KR)

(21) Appl. No.: 18/228,941

(22) Filed: Aug. 1, 2023

(30) Foreign Application Priority Data
Sep. 15, 2022 (KR) 10-2022-0116595
Dec. 30, 2022 (KR) 10-2022-0190787

(51) Int. Cl. H01M 10/26; H01M 4/90; H01M 8/18; H01M 10/42

(52) U.S. Cl. CPC H01M 10/26; H01M 4/90; H01M 8/188; H01M 10/4235

(57) ABSTRACT

Provided is an aqueous zinc battery including: a negative electrode including zinc; a positive electrode disposed to be opposite to the negative electrode; and an electrolyte solution including a zinc salt and an organic acid having two carboxylic acid groups, wherein the organic acid having two carboxylic acid groups has 2 to 4 carbon atoms between the two carboxylic acid groups.

It is intended to provide an electrolyte solution for an aqueous zinc battery and an aqueous zinc battery which prevent a passivation layer such as zinc hydroxide sulfate hydrate (ZHS, ZnSO₄[Zn(OH)₂]₃·xH₂O)) which deteriorates battery performance from being formed in a zinc electrode, maintain a pH of the electrolyte solution, promote uniform zinc deposition during a constant current cycle, and show improved battery cycle performance.

### CROSS-REFERENCE TO RELATED APPLICATIONS

This application claims priority under 35 U.S.C. § 119 to Korean Patent Application No. 10-2022-0116595, filed on Sep. 15, 2022 and Korean Patent Application No. 10-2022-0190787, filed on Dec. 30, 2022, in the Korean Intellectual Property Office, the disclosure of which is incorporated herein by reference in its entirety.

### TECHNICAL FIELD

The following disclosure relates to an electrolyte solution for an aqueous zinc battery and an aqueous zinc battery.

### BACKGROUND

An energy storage system (ESS) is emerging since the demand for fuel-free or renewable energy sources is growing. ESS should provide consistent power transmission during times of highest demand for electricity and non-peak power demand. In addition, ESS is required to meet a grid-scale capacity and requires high safety, low cost, and low maintenance cost, and an aqueous zinc battery (AZIB, aqueous Zn-ion battery) is a promising candidate to satisfy the requirements. Metal zinc (Zn) shows a redox potential with a high degree of negativity as a negative electrode (−0.763 V versus a standard hydrogen electrode (SHE)). In addition, two electron transfer processes for Zn²⁺ deposition provide high theoretical volume and specific capacity of 5855 Ah L⁻¹ and 820 mAh g⁻¹, respectively.

The chemistry of the aqueous zinc battery is highly dependent on electrolyte solution conditions. A commercial aqueous zinc battery based on an alkaline solution is a primary battery since a constituent zincate forms a thick insulating oxide film which prevents zinc plating on a zinc electrode. For more sustainable use, a rechargeable battery has been implemented using a weakly acidic electrolyte solution in a recent study. Since it has no insulating oxide film, repeated zinc plating and stripping are allowed. However, an exposed zinc electrode is vulnerable to corrosion and a H₂ evolution reaction (HER) coupled with oxidation of zinc spontaneously occurs (Formulae 1 to 3). The chemical reaction increases pH and electrolyte salt precipitation. Representatively, a zinc sulfate (ZnSO₄) electrolyte salt forms a zinc hydroxide sulfate hydrate (ZHS, ZnSO₄[Zn(OH)₂]₃·xH₂O) at pH 5.6 (Formula 4). A zinc hydroxide sulfate hydrate (ZHS) passivation layer covers the entire surface of a zinc electrode and a continuous H₂ evolution reaction (HER) maintains pH constant. However, the passivation layer is not effective for achieving uniform zinc plating. Irregular size and direction of the passivation layer disturbs a Zn²⁺ flow and the cycle performance of the aqueous zinc battery is deteriorated by the low ion conductivity of the passivation layer.

Zn⇄Zn²⁺+2e⁻ E=−0.763V vs. SHE (Formula 1)

2H⁺+2e⁻→H₂ (g) E=0V vs. SHE (Formula 2)

2H₂O+2e⁻→H₂ (g)+2OH⁻ E=0−(0.059×pH) V vs. SHE (Formula 3)

3Zn²⁺+6OH⁻+ZnSO₄+xH₂O⇄ZnSO₄[Zn(OH)₂]₃·xH₂O(s) (Formula 4)

In order to mitigate an unpreferred chemical reaction, new electrolyte solution and surface protective layer have been variously studied. A high salt concentration (3-22 M), an organic solvent, an ionic liquid, a deep eutectic electrolyte, gel electrolyte, and the like have been studied in order to build a stable phase layer between solid-electrolyte while suppressing the H₂ evolution reaction (HER). However, the above application method decreases moisture activity, but is costly and has the disadvantage of low ion conductivity of an electrolyte medium.

As an alternative approach, an artificial protective layer using inorganic, carbon, and polymer layers has been introduced, and a protective layer having a thickness of several tens of micrometers may be manufactured in situ. However, the thick layer as such often shows high voltage polarization, low capacity, and an unstable contact with a zinc electrode.

Therefore, a new electrolyte solution for an aqueous zinc battery and a new aqueous zinc battery for solving the problems described above are needed.

### SUMMARY

An embodiment of the present invention is directed to providing an electrolyte solution for an aqueous zinc battery and an aqueous zinc battery which prevent a passivation layer which deteriorates battery performance from being formed in a zinc electrode, maintain the pH of an electrolyte solution, promote uniform zinc deposition during a constant current cycle, and show excellent battery performance.

In one general aspect, an aqueous zinc battery includes: a negative electrode including zinc; a positive electrode disposed to be opposite to the negative electrode; and an electrolyte solution including a zinc salt and an organic acid having two carboxylic acid groups, wherein the organic acid having two carboxylic acid groups has 2 to 4 carbon atoms between the two carboxylic acid groups.

In an exemplary embodiment, the organic acid having two carboxylic acid groups may include at least one selected from the group consisting of glutaric acid, succinic acid, and adipic acid.

In an exemplary embodiment, the organic acid having two carboxylic acid groups may include glutaric acid.

In an exemplary embodiment, a pH of the electrolyte solution may be less than 5.6.

In an exemplary embodiment, the aqueous zinc battery may form a protective layer on the surface of the negative electrode.

In an exemplary embodiment, a thickness of the protective layer may be 0.001 to 500 nm.

In an exemplary embodiment, the protective layer may be a zinc glutarate protective layer.

In an exemplary embodiment, the zinc salt may include at least one selected from the group consisting of zinc sulfate, zinc triflate, zinc acetate, zinc butyrate, zinc glycerate, zinc gluconate, zinc glycolate, zinc formate, zinc lactate, zinc picolinate, zinc propionate, zinc salicylate, zinc tartrate, and zinc undecylenate.

In an exemplary embodiment, the zinc salt may include at least one selected from the group consisting of zinc sulfate and zinc triflate.

In an exemplary embodiment, the positive electrode may include at least one selected from the group consisting of carbon nanotubes, carbon fiber, fullerene, graphite, graphene, carbon black, carbon felt, carbon paper, and ketjen black.

In an exemplary embodiment, the negative electrode may be in contact with the electrolyte solution, the positive electrode may be in contact with a solution including at least one selected from the group consisting of KI, KBr, and KCl, and the electrode may be for a redox flow battery.

In an exemplary embodiment, a concentration ratio of the organic acid having two carboxylic acid groups to the zinc salt may be 0.001:1 to 1:1.

In another general aspect, an electrolyte solution for an aqueous zinc battery includes: a zinc salt; and an organic acid having two carboxylic acid groups, wherein the organic acid having two carboxylic acid groups has 2 to 4 carbon atoms between the two carboxylic acid groups.

In an exemplary embodiment, the organic acid having two carboxylic acid groups may include at least one selected from the group consisting of glutaric acid, succinic acid, and adipic acid.

In an exemplary embodiment, the organic acid having two carboxylic acid groups may include glutaric acid,

Still another general aspect, an aqueous zinc battery includes: a negative electrode including zinc; a zinc organic acid salt protective layer disposed on a surface of the negative electrode; a positive electrode disposed to be opposite to the negative electrode; and an electrolyte solution including a zinc salt, wherein the organic acid of the zinc organic acid salt includes 2 carboxylic acid groups and has 2 to 4 carbon atoms between the two carboxylic acid groups.

In an exemplary embodiment, the zinc organic acid salt protective layer may be a zinc glutarate protective layer.

In an exemplary embodiment, the electrolyte solution may further include an organic acid having two carboxylic acid groups.

Other features and aspects will be apparent from the following detailed description, the drawings, and the claims.

### BRIEF DESCRIPTION OF THE DRAWINGS

FIG. 1 is drawings showing (a-d) SEM images of zinc electrodes after reaction for 24 hours with (a-b) a 1M ZnSO₄ solution containing 0.1 M glutaric acid at pH 4.2 and (c-d) a 1 M ZnSO₄ solution having no glutaric acid at pH 5.3, and (e-f) drawing showing XRD patterns of zinc electrode (e) after 1 hour and (f) after 24 hours, when 0.1 M glutaric acid is present (top) and when no glutaric acid is present (bottom) and (g) pH of the solution as prepared and after 120 hours when 0.1 M glutaric acid is present and when no glutaric acid is present.

FIG. 2 is drawings showing of (a-b) representative voltage profiles of a Zn|Ti battery (a) when 0.01 M glutaric acid is present (pH 5.0) and (b) when no glutaric acid is present, at a current density and a capacity of 1 mA cm⁻² and 1 mAh cm⁻², respectively, (c-d) cycle performance using a solution when 0.01 M glutaric acid is present and when no glutaric acid is present of a Zn|Zn battery at (c) 1 mA cm⁻² and 1 mAh cm⁻², and (d) 0.5 mA cm⁻² and 0.25 mAh cm⁻², (e-f, h-i) SEM images of a zinc electrode after 20 cycles in a Zn|Zn battery (e-f) when 0.01 M glutaric acid is present and (h-i) when no glutaric acid is present, and (g, j) optical microscope images in situ after first zinc deposition.

FIG. 3 is digital photographs of zinc electrodes of a glass beaker Zn|Zn battery for cycle operation for 80 hours in a condition of an Ar gas purging at a current density and a capacity of 1 mA cm⁻² and 1 mAh cm⁻², respectively, using a 1M ZnSO₄ solution as an electrolyte solution (a) when 0.01 M glutaric acid is present at pH 5.0, (b) when 0.01 M glutaric acid is present at pH 3.1, and (c) when no glutaric acid is present at pH 5.3.

FIG. 4 is (a) a schematic diagram of RFB composed of a carbon electrode with a zinc electrode, a nafion membrane, and 1M KI and 1M KCl solutions in a 1M ZnSO₄ solution (pH 5.0) in which 0.01 M glutaric acid is present, (b) a cyclic voltammogram of a zinc electrode (Zn/Zn²⁺) and a I⁻/I₃⁻ redox pair at 50 mV s⁻¹, (c) constant current cycle performance (capacity: 26.8 mAh) in various current density curves when glutaric acid is present and when no glutaric acid is present, (d-e) high magnified (c) graphs in a selected period (d) when glutaric acid is present and (e) when no glutaric acid is present, and (f) a drawing showing energy efficiency (EE) and coulomb efficiency (CE) when current densities are different.

### DETAILED DESCRIPTION OF EMBODIMENTS

Hereinafter, the electrolyte solution for an aqueous zinc battery and the aqueous zinc battery of the present disclosure will be described.

Technical terms and scientific terms used in the present specification have the general meaning understood by those skilled in the art to which the present invention pertains unless otherwise defined, and a description for the known function and configuration obscuring the present invention will be omitted in the following description.

In addition, the singular form used in the present specification may be intended to also include a plural form, unless otherwise indicated in the context.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms. Unless otherwise defined in the specification of the present invention, values which may be outside a numerical range due to experimental error or rounding off of a value are also included in the defined numerical range.

The term “comprise” in the present specification is an open-ended description having a meaning equivalent to the term such as “is/are provided”, “contain”, “have”, or “is/are characterized, and does not exclude elements, materials, or processes which are not further listed.

The present disclosure provides an aqueous zinc battery including: a negative electrode including zinc; a positive electrode disposed to be opposite to the negative electrode; and an electrolyte solution including a zinc salt and an organic acid having two carboxylic acid groups, wherein the organic acid having two carboxylic acid groups has 2 to 4 carbon atoms between the two carboxylic acid groups.

In an exemplary embodiment, the organic acid having two carboxylic acid groups may include at least one selected from the group consisting of glutaric acid, succinic acid, and adipic acid. Specifically, the organic acid having two carboxylic acid groups may include glutaric acid.

In an exemplary embodiment, a concentration of the organic acid having two carboxylic acid groups may be 10 M or less, 5 M or less, 1 M or less, 0.5 M or less, 0.3 M or less, 0.1 M or less, 0.05 M or less, 0.03 M or less, or 0.02 M or less. In addition, the concentration of the organic acid having two carboxylic acid groups may be 0.0001 M or more, 0.001 M or more, 0.005 M or more, or 0.01 M or more. The concentration of the organic acid having two carboxylic acid groups may be 0.0001 M to 10 M, 0.001 M to 1 M, or 0.01 M to 0.1 M.

When the electrolyte solution of the aqueous zinc battery includes at least one selected from the group consisting of succinic acid and adipic acid, a protective layer is formed on the surface of a zinc electrode. As the protective layer is formed on the surface of the zinc electrode, formation of a passivation layer which has irregular size and direction and low ion conductivity such as a zinc hydroxide sulfate hydrate (ZHS) on a zinc electrode is prevented. In addition, the protective layer formed on the surface of the zinc electrode maintains the pH of the electrolyte solution and may promote uniform zinc deposition during a constant current cycle. Therefore, the aqueous zinc battery according to the present disclosure has a significant effect of showing excellent battery performance such as improved coulomb efficiency (CE) and cycle performance.

In an exemplary embodiment, a pH of the electrolyte solution may be less than 5.6, 5.5 or less, 5.4 or less, or 5.3 or less. In addition, the pH of the electrolyte solution may be 3.0 or more, 3.1 or more, 3.5 or more, 4.0 or more, 4.5 or more, or 5.0 or more. The pH of the electrolyte solution may be 3.0 more and less than 5.6 or 4.5 or more and less than 5.6.

When the pH of the electrolyte solution is 3.0 or more and less than 5.6, excellent battery performance such as improved coulomb efficiency (CE) and cycle performance is shown. When the pH of the electrolyte solution is 4.5 or more and less than 5.6, battery performance such as coulomb efficiency (CE) and cycle performance is the best.

In an exemplary embodiment, the pH of the electrolyte solution may be adjusted by adding a base compound. The base compound may be KOH or LiOH, but is not limited thereto.

In an exemplary embodiment, the aqueous zinc battery may form a protective layer on the surface of the negative electrode. As the protective layer is formed on the surface of a negative electrode including zinc, formation of a passivation layer which has irregular size and direction and low ion conductivity such as a zinc hydroxide sulfate hydrate (ZHS) on the negative electrode is prevented. In addition, the protective layer formed on the surface of the negative electrode may maintain the pH of the electrolyte solution and promote uniform zinc deposition during a constant current cycle. Therefore, the aqueous zinc battery according to the present disclosure has a significant effect of showing excellent battery performance such as improved coulomb efficiency (CE) and cycle performance.

In an exemplary embodiment, a thickness of the protective layer may be 500 nm or less, 300 nm or less, 100 nm or less, 50 nm or less, 30 nm or less, or 10 nm or less and 0.001 nm or more, 0.01 nm or more, 0.1 nm or more, 1 nm or more, 2 nm or more, or 5 nm or more. Specifically, the thickness of the protective layer may be 0.001 to 500 nm, 0.1 to 100 nm, 1 to 50 nm, or 2 to 50 nm.

In an exemplary embodiment, the protective layer may be a zinc glutarate protective layer. In particular, when the electrolyte solution includes glutaric acid, a zinc glutarate protective layer is formed on the surface of the negative electrode including zinc. When the zinc glutarate protective layer is formed on the surface of the negative electrode, the best battery performance such as coulomb efficiency (CE) and cycle performance is shown.

In an exemplary embodiment, the zinc salt may include at least one selected from the group consisting of zinc sulfate, zinc triflate, zinc acetate, zinc butyrate, zinc glycerate, zinc gluconate, zinc glycolate, zinc formate, zinc lactate, zinc picolinate, zinc propionate, zinc salicylate, zinc tartrate, and zinc undecylenate, but is not limited thereto. Specifically, the zinc salt may include at least one selected from the group consisting of zinc sulfate and zinc triflate. More specifically, the zinc salt may include zinc sulfate.

In an exemplary embodiment, a concentration of the zinc salt may be 100 M or less, 50 M or less, 10 M or less, 5 M or less, or 1 M or less. In addition, the concentration of the zinc salt may be 0.0001 M or more, 0.001 M or more, 0.01 M or more, 0.05 M or more, 0.1 M or more, 0.5 M or more, or 1 M or more. The concentration of the zinc salt may be 0.001 M to 100 M, 0.01 M to 10 M, or 0.1 M to 1 M.

In an exemplary embodiment, a concentration ratio of the organic acid having two carboxylic acid groups to the zinc salt may be 0.0001:1 to 10:1, 0.001:1 to 1:1, or 0.01:1 to 0.1:1.

In an exemplary embodiment, the positive electrode may include at least one selected from the group consisting of carbon nanotubes, carbon fiber, fullerene, graphite, graphene, carbon black, carbon felt, carbon paper, and ketjen black, but is not limited thereto. Specifically, the positive electrode may include a carbon nanotube.

In an exemplary embodiment, the aqueous zinc battery may further include a separator disposed between the positive electrode and the negative electrode. The separator may include at least one selected from the group consisting of polyolefin-based resins such as polyethylene and polypropylene; fluorine-based resins such as polytetrafluoroethylene and polyvinylidene fluoride; polyamide-based resins; and polyimide-based resins such as polyamideimide and polyimide, but is not limited thereto. In addition, the separator may include inorganic fiber or inorganic powder such as glass fiber, mica, alumina, and silica without limitation.

In an exemplary embodiment, the negative electrode may be in contact with the electrolyte solution, and the positive electrode may be in contact with a solution including at least one selected from the group consisting of KI, KBr, and KCl. In addition, the aqueous zinc battery may be for a redox flow battery.

The redox flow battery is a secondary battery using an oxidation-reduction reaction of a redox couple, active material dissolved in an electrolyte solution, unlike a conventional secondary battery storing electric energy in an electrode including an active material. Due to the battery characteristics of the redox flow battery, a stack responsible for output and an electrolyte solution unit responsible for capacity are independently spaced, so that capacity and output may be freely designed. Since the redox flow battery forms only an oxidation-reduction reaction by donating and accepting electrons in an electrode unlike other batteries, there is no structural change of the electrode itself, and since the electrode and the active material are separated, there is no side reaction between the two materials, and the stability and the life of the battery is better than those of other secondary batteries. An electrolytic solution which is one of the core materials of the redox flow battery is used by dissolving an active material having a different oxidation state in an aqueous or non-aqueous solvent. Herein, various redox flow batteries are formed depending on the type of active materials, and are classified into aqueous and non-aqueous electrolytes depending on the type of solvent. Requirements of the electrolyte solution including an active material include rapid reactivity with an electrode and reversibility, and in order to increase energy density, the electrolyte solution including an active material should have a large potential window and a high solubility.

When the aqueous zinc battery according to the present disclosure is used in a redox flow battery, a protective layer is formed on the surface of a zinc electrode of the redox flow battery, and a passivation layer having irregular size and direction and low ion conductivity such as a zinc hydroxide sulfate hydrate (ZHS) is prevented from being formed in the zinc electrode. In addition, the protective layer formed on the surface of the zinc electrode maintains the pH of the electrolyte solution and may promote uniform zinc deposition during a constant current cycle. Therefore, there is a significant effect of showing excellent performance of the redox flow battery such as improved coulomb efficiency (CE) and cycle performance.

In another general aspect, an electrolyte solution for an aqueous zinc battery includes: a zinc salt; and an organic acid having two carboxylic acid groups, wherein the organic acid having two carboxylic acid groups has 2 to 4 carbon atoms between the two carboxylic acid groups. Contents overlapping the above description will be omitted.

In an exemplary embodiment, the organic acid having two carboxylic acid groups may include at least one selected from the group consisting of glutaric acid, succinic acid, and adipic acid, but is not limited thereto. Specifically, the organic acid having two carboxylic acid groups may include glutaric acid.

In an exemplary embodiment, a pH of the electrolyte solution may be less than 5.6, 5.5 or less, 5.4 or less, or 5.3 or less. In addition, the pH of the electrolyte solution may be 3.0 or more, 3.1 or more, 3.5 or more, 4.0 or more, 4.5 or more, or 5.0 or more. The pH of the electrolyte solution may be 3.0 more and less than 5.6 or 4.5 or more and less than 5.6.

In an exemplary embodiment, the zinc salt may include at least one selected from the group consisting of zinc sulfate, zinc triflate, zinc acetate, zinc butyrate, zinc glycerate, zinc gluconate, zinc glycolate, zinc formate, zinc lactate, zinc picolinate, zinc propionate, zinc salicylate, zinc tartrate, and zinc undecylenate, but is not limited thereto.

In addition, the present disclosure provides an aqueous zinc battery including: a negative electrode including zinc; a zinc organic acid salt protective layer disposed on a surface of the negative electrode; a positive electrode disposed to be opposite to the negative electrode; and an electrolyte solution including a zinc salt, wherein the organic acid of the zinc organic acid salt includes 2 carboxylic acid groups and has 2 to 4 carbon atoms between the two carboxylic acid groups. Contents overlapping the above description will be omitted.

When the zinc organic acid salt protective layer is formed on the surface of the zinc negative electrode of the aqueous zinc battery, a passivation layer having irregular size and direction and low ion conductivity such as zinc hydroxide sulfate hydrate (ZHS) is prevented from being formed on the zinc negative electrode. In addition, the zinc organic acid salt protective layer formed on the surface of the zinc negative electrode may maintain the pH of the electrolyte solution and promote uniform zinc deposition during a constant current cycle. Therefore, the aqueous zinc battery according to the present disclosure has a significant effect of showing excellent battery performance such as improved coulomb efficiency (CE) and cycle performance.

In an exemplary embodiment, the zinc organic acid salt protective layer may be a zinc glutarate protective layer.

In an exemplary embodiment, the electrolyte solution may further include an organic acid having two carboxylic acid groups. In addition, in an exemplary embodiment, the organic acid may have 2 to 4 carbon atoms between the two carboxylic acid groups.

In an exemplary embodiment, the organic acid having two carboxylic acid groups may include at least one selected from the group consisting of glutaric acid, succinic acid, and adipic acid. Specifically, the organic acid having two carboxylic acid groups may include glutaric acid.

Hereinafter, the present disclosure will be described in more detail with reference to the examples and the comparative examples. However, the following examples and comparative examples are only an example for describing the present disclosure in more detail, and do not limit the present disclosure in any way. Unless otherwise stated, the unit of temperature is ° C., and unless otherwise stated, the unit of an amount of a composition used is wt %.

### Experimental Example 1: Characterization Method

The pH of an electrolyte solution was measured using a pH meter (Seven Excellence S400, METTLER TOLEDO) at 24° C. A zinc electrode tested for analysis of a zinc electrode surface was lightly washed with deionized water and dried in ambient conditions for 12 hours. A surface shape and an element distribution were observed using a field emission scanning electron microscope (FE-SEM, S-4800 and SU-8230, HITACH) and an energy dispersion analyzer. Crystallographic reflection of a sample was identified using Powder X-ray diffraction (XRD) of CuKα radiation and a D/tex Ultra 250 detector (SmartLab, RIGAKU) and a PDXL analysis software from KAIST Analysis Center for Research Advancement (KARA). A Fourier transform infrared (FTIR) spectrum was obtained from an attenuated total reflection infrared (ATR-IR) mode (Nicolet iS50 embedded diamond ATR module, Thermo Scientific). Raman spectroscopy using 514 nm laser (LabRAM HR Evolution Visible_NIR, HORIBA) was used in chemical analysis of zinc glutarate powder. An X-ray monochromator (K-alpha, Thermo VG Scientific) using an X-ray photoelectron spectroscopy (XPS) analysis program (Avantage, Thermo Fisher Scientific) having Al Kα characterized chemical components on the surface of a zinc electrode. All XPS spectra were corrected from Zn (II) at 1021.8 eV of a Zn 2p binding energy region.

### Experimental Example 2: Electrochemical Examination

A constant current examination was performed at room temperature using a battery cycler (PNE solution) or an electrochemical work station (SP-200, Biologic). The test was started after 6 hours in OCP. In addition, a battery pause time of 5 minutes was programmed after charge and discharge processes.

### Preparation Example 1: Chemical Synthesis of Zinc Glutarate and Zinc Hydroxide Sulfate Hydrate

1 g (2.68 mmol) of zinc perchlorate hexahydrate (Zn(ClO₄)₂·6H₂O, Sigma Aldrich) and 0.252 g (2.68 mmol) of glutaronitrile (TCI, 96%) were mixed with 24 mL of deionized water. The mixed solution was heated at 160° C. for 40 hours using a teflon-lined reaction vessel. After cooling the solution to room temperature, zinc glutarate powder was collected through centrifugation, washed with deionized water, and dried overnight at 40° C. Zinc hydroxide sulfate hydrate (ZHS, ZnSO₄ [Zn(OH)₂]₃·xH₂O) powder was obtained by pH adjustment of a 1.0M ZnSO₄ solution. A 1.0 M LiOH (Sigma Aldrich, 99%) solution was added dropwise to the ZnSO₄ solution with stirring until the pH reached ˜5.5. Immediately, white powder deposition was observed. The powder was filtered, washed with deionized water, and dried overnight at 65° C.

### Preparation Example 2: Manufacture of Non-Aqueous Electrolyte Battery

In the case of a non-aqueous electrolyte battery, anhydrous acetonitrile (Sigma Aldrich, 99.8%) and 1.0 M zinc triflate (Zn(OTf)₂, TCI, 98%) were used. A Zn(OTf)₂ salt was dried at 120° C. for 12 hours using a glass vacuum oven (B-585, Buchi). ACN was dried for at least 2 days before use using a molecular sieve (Sigma Aldrich, 4 Å). A glass beaker cell was composed of two metal zinc electrodes and ˜30 mL of an electrolyte solution. The zinc electrode was connected to an alligator clip and a Cu wire. The completed battery was purged with Ar gas at least 5 minutes before a battery test.

### Example 1: Manufacture of Zn|Ti Battery

A zinc foil (Welcos, thickness=50 μm) was washed with acetone, ethanol, and deionized water, and dried in ambient conditions before use. A Ti foil (Welcos, diameter (d)=14 mm, t=20 μm) was treated for 10 minutes using NH₄OH/H₂O₂ (7/3 v/v), respectively, before use. The electrolyte solution was prepared using a 1.0 M zinc sulfate monohydrate (ZnSO₄·H₂O, Sigma Aldrich) and 0.01 M glutaric acid (Sigma Aldrich). The pH of the electrolyte solution was adjusted to 5.0 using LiOH (Sigma Aldrich) or KOH (Daejung). The aqueous electrolyte solution was degassed by Ar gas bubbling at least 2 minutes before.

A Cr2032-type coin battery and a glass beaker battery were used in the Zn|Ti battery test. In the case of a coin battery test, Ti and a zinc foil used as a positive electrode and a negative electrode (d=14 and 15 mm) were assembled with 150 μL of an Ar gas purge electrolyte solution in a glove box (MOTEK) filled with glass fiber pieces (GF/C, Whatman, d=19 mm) and Ar used as a separator. A Ti foil (Welcos, t=20 μm) was treated for 10 minutes using NH₄OH/H₂O₂ (7/3 v/v) before use.

The Zn|Ti battery achieved 99.7% coulomb efficiency (CE) and ˜450 cycles after 10 cycles at a current density and a capacity of 1 mA cm⁻² and 1 mAh cm⁻², respectively.

### Example 2

The process was performed in the same manner as in Example 1 except using an electrolyte solution at pH 3.1.

The Zn|Ti battery achieved 98.7% coulomb efficiency (CE) and ˜200 cycles after 10 cycles at a current density and a capacity of 1 mA cm⁻² and 1 mAh cm⁻², respectively.

### Comparative Example 1

The process was performed in the same manner as in Example 1, except that no glutaric acid was present in the electrolyte solution.

The Zn|Ti battery achieved only 92.1% coulomb efficiency (CE) and 10 cycles after 10 cycles at a current density and a capacity of 1 mA cm⁻² and 1 mAh cm⁻², respectively.

### Example 3: Manufacture of Zn|Zn Battery

A zinc foil (Welcos, thickness=50 μm) was washed with acetone, ethanol, and deionized water, and dried in ambient conditions before use. The electrolyte solution was prepared using a 1.0 M zinc sulfate monohydrate (ZnSO₄·H₂O, Sigma Aldrich) and 0.01 M glutaric acid (Sigma Aldrich). The pH of the solution was adjusted using LiOH (Sigma Aldrich) or KOH (Daejung). The aqueous electrolyte solution was degassed by Ar gas bubbling at least 2 minutes before.

A CR2032-type coin battery and a glass beaker battery were used in the Zn|Zn battery test. In the case of a coin battery test, two metal zinc foils used as a positive electrode and a negative electrode (d=14 and 15 mm) were assembled with 150 μL of an Ar gas purge electrolyte solution in a glove box (MOTEK) filled with glass fiber pieces (GF/C, Whatman, d=19 mm) and Ar used as a separator.

The Zn|Zn battery showed cycle performance of 1300 hours at 1 mA cm⁻² and 1 mAh cm⁻². Cycles of 4000 hours or more were achieved at 0.5 mA cm⁻² and 0.25 mAh cm⁻².

### Example 4

The process was performed in the same manner as in Example 3, except that the electrolyte solution included succinic acid instead of glutaric acid.

The Zn|Zn battery showed cycle performance of ˜130 hours at 1 mA cm⁻² and 1 mAh cm⁻². The battery completed cycles at ˜125 hours as voltage polarization increased at 10 mA cm⁻² and 5 mAh cm⁻².

### Example 5

The process was performed in the same manner as in Example 3, except that the electrolyte solution included adipic acid instead of glutaric acid.

The Zn|Zn battery showed cycle performance of ˜250 hours at 1 mA cm⁻² and 1 mAh cm⁻². The battery completed cycles at ˜230 hours as voltage polarization increased at 10 mA cm⁻² and 5 mAh cm⁻².

### Comparative Example 2

The process was performed in the same manner as in Example 3, except that no glutaric acid was present in the electrolyte solution.

The Zn|Zn battery showed cycle performance of ˜50 hours at 1 mA cm⁻² and 1 mAh cm⁻². The battery completed cycles at ˜130 hours as voltage polarization increased at 0.5 mA cm⁻² and 0.25 mAh cm⁻².

### Example 6: Manufacture of Zn—I Redox Flow Battery

A Zn—I redox flow battery was assembled using a zinc foil (t=50 μm, geometric area=6 cm², 4-layer stacked), a Nafion 212 K⁺ exchange membrane (t=50.8 μm), and a porous carbon nanotube/carbon felt electrode. Three holes (d=3 mm) were punched in the 4-layer zinc foil for the flow of the electrolyte solution. A carbon electrode was manufactured by the following process. A carbon felt piece (XF30A, Toyobo, t=3 mm, geometric=20×30 mm) was washed with deionized water by sonication for 1 hour, and dried at 70° C. for 4 hours. Separately, 20 mg of multi-walled carbon nanotubes (Sigma Aldrich, 98%) were dispersed in 50 mL of dimethylformamide (Sigma Aldrich, 99.8%) and sonication was performed for 30 minutes. The prepared carbon felt was immersed in a carbon nanotube solution and sonication was performed for one more hour. Then, the carbon felt including carbon nanotubes was dried at 70° C. for 2 hours, and then dried at 250° C. for 12 hours. In the case of the electrolyte solution, 10 mL of a 1 M ZnSO₄ solution having 0.01 M glutaric acid was used as a negative electrode side. 20 mL of the electrolyte solution in the positive electrode side included 1.0 M KI (Sigma Aldrich) and 1.0 M KCl (Sigma Aldrich). The pH of all electrolyte solutions was adjusted to pH 5.3 to 5.5, using 10 M KOH (Daejung). In the redox flow battery, two electrolyte solutions were cycled at a flow velocity of 20 mL/min using a peristaltic pump (Shenchen, model LabV1 and/or Masterflex model 77202-60). The redox flow battery was cycled at room temperature, and a charge capacity was fixed to 26.8 mAh.

The redox flow battery was operated stably for ˜360 hours (100 cycles). Thereafter, current density was continuously increased to 5 mA·cm² for 40 cycles, and showed 7.5 mA·cm² for 40 cycles, to 10 mA·cm² (˜1C) for 140 cycles, and 2.5 mA·cm² for 30 cycles. That is, a total of 350 cycles or more of operation was allowed.

### Comparative Example 3

The process was performed in the same manner as in Example 6, except that no glutaric acid was present in the electrolyte solution.

In this case, the redox flow battery achieved only 3 cycles (<24 hours), and voltage polarization was greatly expanded.

Growth and Role In Situ of Protective Layer Under Non-Electrochemical (Open Potential, OCP) and Electrochemical Conditions (Charge-Discharge Process)

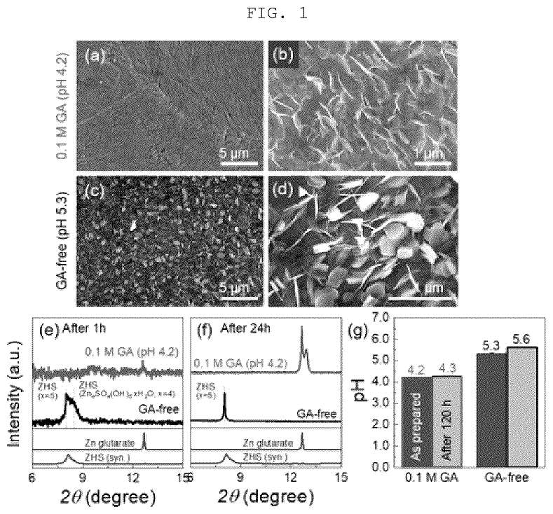

When glutaric acid is present or absent in the electrolyte solution under non-electrochemical circumstances, two different surface layers were chemically formed. First, a 1 M ZnSO₄ electrolyte solution including 0.1 M glutaric acid was prepared, and its pH was adjusted to 4.2. The concentration of glutaric acid was 10 times higher than the concentration used in the charge and discharge conditions (0.01 M glutaric acid at pH 5.0) in order to explicitly analyze a protective layer form and a spectrum signal. After the zinc electrode was immersed in the electrolyte solution for 24 hours, a laminar-shaped layer covered a zinc surface as seen in the scanning electron microscope (SEM) image ((a)-(b) of FIG. 1). X-ray diffraction (XRD) peak=12.7° and 12.8° ((f) of FIG. 1) at 29 corresponded to zinc glutarate. The electrolyte solution was maintained at pH 4.3 after 120 hours ((g) of FIG. 1), and a zinc glutarate layer stabilized the surface of the zinc electrode.

However, a 1 M ZnSO₄ solution (pH 5.3) including no glutaric acid formed a zinc hydroxide sulfate hydrate (ZHS) passivation layer in the zinc electrode. After immersion for 24 hours, submicron-sized hexagonal flakes were shown ((c)-(d) of FIG. 1), and 002 reflection at 2θ=8.0° in XRD showed formation of a pentahydrate of zinc hydroxide sulfate hydrate (ZHS). Growth of zinc hydroxide sulfate hydrate (ZHS) was rapid and continuous in the 1 M ZnSO₄ electrolyte. The structure of the zinc hydroxide sulfate hydrate (ZHS) was shown in XRD after 1 hour, and various hydrate structures occurred due to a subtle difference of drying conditions ((e) of FIG. 1) and was substantially expanded after 120 hours. In this process, the pH of the solution reached 5.6 ((g) of FIG. 1), and the equilibrium conditions for forming zinc hydroxide sulfate hydrate (ZHS) was set. A rapid and constant H₂ evolution reaction (HER) maintained the pH at 5.6 during growth of zinc hydroxide sulfate hydrate (ZHS), and then the pH was increased. Therefore, the process of forming zinc hydroxide sulfate hydrate (ZHS) was the same regardless of initial pH when no glutaric acid was included. However, when the glutaric acid was included, it appeared that the reaction suppressed precipitation of zinc hydroxide sulfate hydrate (ZHS) even after 120 hours and stabilized the electrolyte solution at pH<5.6. Therefore, the results demonstrate a competitive chemical reaction between the H₂ evolution reaction (HER) and glutaric acid.

The formation of initial zinc hydroxide sulfate hydrate (ZHS) was due to a rapid H₂ evolution reaction (HER) and increased pH around the zinc surface. However, the pH change started glutaric acid deprotonation related to two pKa values of glutaric acid, 4.35 (pKₐ₁) and 5.42 (pKₐ₂) to allow an end carboxylate group to be coordinated with Zn²⁺ in the electrolyte solution (Formula 5).

nZn²⁺+2n(⁻OOC(CH₂)₃COO⁻)+4n(H⁺)→[Zn(OOC(CH₂)₃COO⁻)₂]ₙ+4n(H⁺) (Formula 5)

Next, the role of zinc glutarate under electrochemical conditions was confirmed. The electrolyte solution was optimized with 0.01 M glutaric acid in a 1M ZnSO₄ solution adjusted to pH 5.0. The high pH conditions close to pKₐ₂ of glutaric acid help form an appropriate zinc glutarate protective layer in the zinc electrode even with use of a small amount of glutaric acid. The thickness of the zinc glutarate protective layer before the test was determined to be ˜48 nm after 24 hours in OCP and maintained constant even after 72 hours, and the pH of the solution was stabilized at 5.2. This suggested that the formation of zinc glutarate was almost completed.

As a control group, an electrolyte solution having 0.01 M glutaric acid at pH 3.1 and an electrolyte solution having no glutaric acid (pH 5.3) were prepared. The zinc electrode in the former electrolyte solution underwent serious H₂ evolution reaction (HER) and thus, its pH was increased to 4.2. However, in spite of a strong H₂ evolution reaction (HER) in a strong acid solution, pH was maintained at less than 5.6 due to a zinc glutarate layer. In the conditions having no latter glutaric acid, the zinc hydroxide sulfate hydrate (ZHS) was formed predominantly.

Zn|Ti Battery

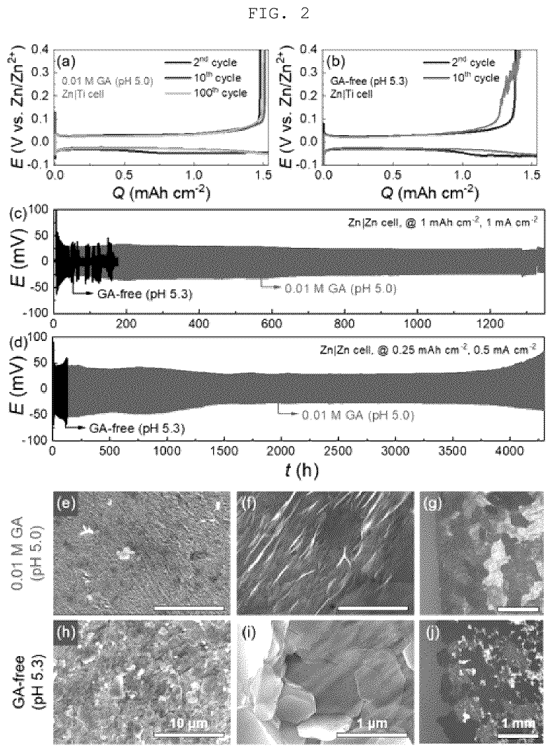

A Zn|Ti battery using an optimal electrolyte solution (0.01 M glutaric acid at pH 5.0) achieved 99.7% coulomb efficiency (CE) after 10 cycles at a current density and a capacity of 1 mA cm⁻² and 1 mAh cm⁻², respectively. These results were better than the results of the control group which were 98.7% and 92.1% CE, respectively for 0.01 M glutaric acid in the electrolyte solution at pH 3.1 having no glutaric acid ((a) and (b) of FIG. 2). In terms of cycle performance, the 0.01 M glutaric acid additive achieved ˜450 cycles at pH 5.0, as compared with ˜200 cycles at pH 3.1. In the conditions having no glutaric acid achieved only 10 cycles, and thus, it was confirmed that ZHS deteriorated battery performance.

Zn|Zn Battery

A Zn|Zn using an optimal electrolyte solution (0.01 M glutaric acid at pH 5.0) achieved the cycle performance of 1300 hours at 1 mA cm⁻² and 1 mAh cm⁻², but a Zn|Zn battery using an electrolyte solution having no glutaric acid showed only the cycle performance of ˜50 hours ((c) of FIG. 2). The battery using the electrolyte solution including glutaric acid showed better cycle performance at various current densities. An optimal battery at the low current density of 0.5 mA cm⁻² achieved cycles of 4000 hours or more at a capacity of 0.25 mAh cm⁻² ((d) of FIG. 2). The battery including the electrolyte solution having no glutaric acid had increased voltage polarization at ˜130 hours, and the cycle was completed.

During the cycle, the zinc glutarate layer maintained stably. An SEM image showed a uniform and dense laminar film in the zinc electrode after 20 cycles ((e)-(f) of FIG. 2). Though several hexagonal ZHS flakes were observed at pH 5.0-5.2, the growth rate was slower than that in the conditions having no glutaric acid. Excellent long-term cycle performance was resulted from the zinc glutarate layer and the electrolyte solution including glutaric acid.

When there was no glutaric acid and the zinc glutarate layer, ZHS flakes were thicker and expanded during the cycle ((h)-(i) of FIG. 2). The ZHS flakes were >1 μm and randomly oriented after 20 cycles. The voltage polarization increased at a low current density ((d) of FIG. 2) may be understood from the expanded ZHS flakes.

The surface layer determined the shape of deposited zinc. Zinc in the optimal conditions was uniformly deposited on the zinc electrode as confirmed from the optical microscope and the SEM image after the first zinc deposition process ((g) of FIG. 2). In contrast, deposited zinc was aggregated so that a 10-30 m cluster was formed in the ZHS layer in an electrolyte solution having no glutaric acid ((j) of FIG. 2).

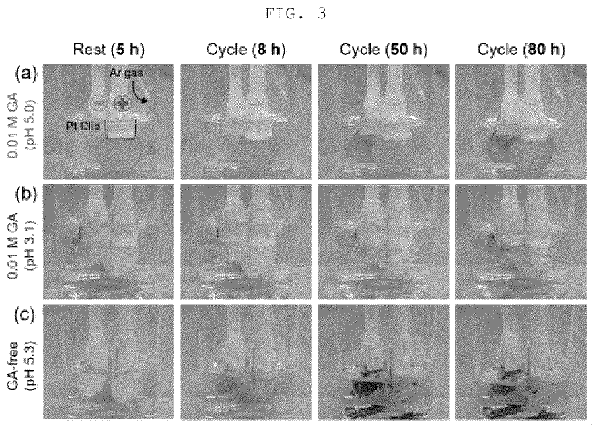

When an electrolyte solution having glutaric acid was used, dendritic zinc was not observed after cycles of 80 hours ((a) of FIG. 3). Large air bubbles occurred in only a platinum clip wiring a zinc electrode. Though violent H₂ bubbles occurred at low pH (pH 3.1), dendritic zinc was not formed in the presence of 0.01 M glutaric acid ((b) of FIG. 3). In contrast, when an electrolyte solution having no glutaric acid was used, black dendritic zinc lump was formed during the cycle ((c) of FIG. 3). The lump fell off in a subsequent zinc stripping step, and the process was repeated during the cycle. The randomly oriented ZHS flakes interfered with a Zn²⁺ flow and formed dendritic zinc.

The effect of glutaric acid was compared with the case of using other dicarboxylic acids such as succinic acid and adipic acid. The pKₐ₁ and pKₐ₂ values thereof were similar to the values of glutaric acid, but an alkyl chain length was different. The constant current performance of the Zn|Zn symmetric battery using succinic acid or adipic acid was somewhat lowered as compared with the case of using glutaric acid in the conditions of 1 mA cm⁻² and 1 mAh cm⁻², and 0.5 mA cm⁻² and 0.25 mAh cm⁻², but showed better performance than the case of using no glutaric acid.

In addition, the role of the zinc glutarate protective layer was confirmed in a non-aqueous electrolyte solution in which formation of HER and ZHS was suppressed (1 M zinc triflate in acetonitrile). Though 0.01 M glutaric acid formed a zinc glutarate layer in acetonitrile, crystallinity was decreased due to the incomplete glutaric acid deprotonation. The Zn|Zn battery showed >22 times higher cycle performance (595 hours) than 27 hours when an electrolyte solution having no glutaric acid was used. The exposed zinc battery easily formed a unpreferred solid-electrolyte interface or was contaminated to promote the growth of dendritic zinc.

Zn—I Redox Flow Battery

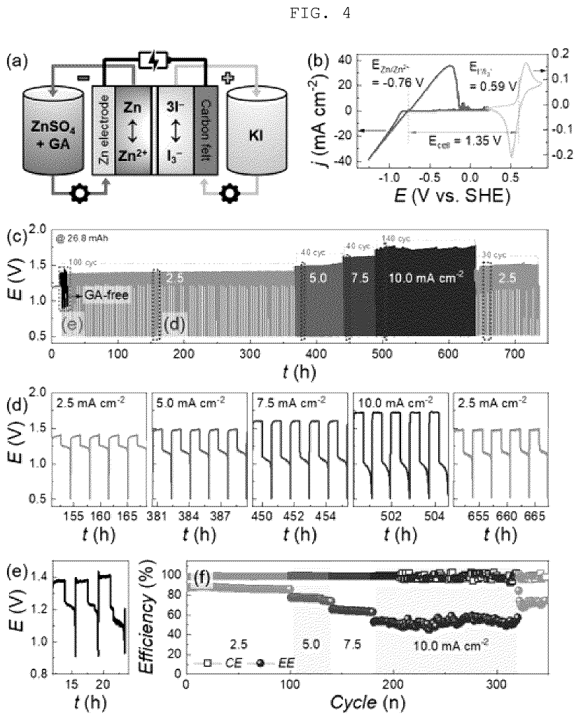

An optimal electrolyte solution was introduced to a Zn—I redox flow battery (RFB, (a) of FIG. 4). A zinc electrode (thickness: 50 μm, geometric area: 6 cm²) and 10 mL of a 1M ZnSO₄ electrolyte solution having 0.01 M glutaric acid (pH=5.0-5.3, adjusted with KOH) or not was introduced to a negative electrode side. A positive electrode electrolyte solution was 20 mL of a 1 M KI aqueous solution forming iodide/triiodide (I⁻/I₃⁻) redox pair, and 1 M KCl was added as a supporting electrolyte solution. Carbon nanotube/carbon felt was used as a positive electrode. The cyclic voltammogram of each half battery showed Zn/Zn²⁺ and I⁻/I₃⁻ redox wave forms at −0.76 and 0.59 V, respectively to SHE to produce a battery voltage of −1.36 V ((b) of FIG. 4). A continuous solution flow (20 mL min⁻¹) during a pause period of 12 hours was sufficient for forming a zinc glutarate layer in the zinc electrode. When the constant current cycle was performed at 2.5 mA cm⁻² (˜0.3C) and a limited charge capacity of 26.8 mAh, Zn—I RFB prepared as an optimal electrolyte solution was stably operated for ˜360 hours (100 cycles, (c) of FIG. 4). Continuously, the current density was increased to 5 mA·cm² for 40 cycles, and showed 7.5 mA·cm² for 40 cycles, to 10 mA·cm² (˜1C) for 140 cycles, and 2.5 mA·cm² for 30 cycles. All constant current profiles were constant during additional 250 cycles ((c)-(d) of FIG. 4). The voltage polarization in the later cycle at 2.5 mA cm⁻² was slightly higher than that observed during initial cycle at the same current density ((d) of FIG. 4, final 2.5 mA cm⁻²). However, a decrease in discharge capacity was not observed and formation of a stable interface layer was shown. In contrast, the same RFB using an electrolyte solution having no glutaric acid achieved only 3 cycles (<24 hours) and its voltage polarization was greatly expanded ((e) of FIG. 4). Zn—I RFB including 0.01 M glutaric acid showed energy efficiency (EE) of 87% and 55%, respectively during the initial period at 2.5 and 10 mA cm⁻², and a constant CE average was 99.22% ((f) of FIG. 4). The RFB results as such successfully demonstrated the function of the protective layer of zinc glutarate in the aqueous zinc battery and its availability at high current density.

The electrolyte solution for an aqueous zinc battery and the aqueous zinc battery according to the present disclosure prevent a passivation layer which deteriorates battery performance from being formed in a zinc electrode, maintain the pH of the electrolyte solution, promote uniform zinc deposition during a constant current cycle, and show excellent battery cycle performance.

In the electrolyte solution according to the present disclosure, a Zn²⁺ coordination compound is used for spontaneous layer formation, and the two carboxylic acid groups serve as a building block for forming a three-dimensional protective layer. That is, when the electrolyte solution including a zinc salt and an organic acid having two carboxylic acid groups according to the present disclosure is used in an aqueous zinc battery, a zinc protective layer is formed in situ.

Specifically, a H₂ evolution reaction (HER) which spontaneously occurs in a zinc electrode promotes deprotonation of the organic acid having two carboxylic acid groups included in the electrolyte solution. Zn²⁺ forms a three-dimensional protective layer with the deprotonated organic acid.

As the protective layer is formed on the surface of the zinc electrode, formation of a passivation layer which has irregular size and direction and low ion conductivity such as a zinc hydroxide sulfate hydrate (ZHS) on a zinc electrode is prevented. In addition, the protective layer formed on the surface of the zinc electrode maintains the pH of the electrolyte solution and may promote uniform zinc deposition during a constant current cycle.

Besides, an aqueous zinc battery manufactured by including the electrolyte solution for an aqueous zinc battery according to the present disclosure has a significant effect of showing excellent battery performance such as improved coulomb efficiency (CE) and cycle performance.

Hereinabove, the exemplary embodiment of the present invention was described, however, various modifications and equivalent range may be used in the present invention, and it is apparent that the above examples may be properly modified and identically applied. Therefore, the above description does not limit the scope of the present invention which is defined by the claims which follow.

What is claimed is:

1. An aqueous zinc battery comprising:
a negative electrode including zinc;
a positive electrode disposed to be opposite to the negative electrode; and
an electrolyte solution including a zinc salt and an organic acid having two carboxylic acid groups,
wherein the organic acid having two carboxylic acid groups has 2 to 4 carbon atoms between the two carboxylic acid groups.

2. The aqueous zinc battery of claim 1, wherein the organic acid having two carboxylic acid groups includes at least one selected from the group consisting of glutaric acid, succinic acid, and adipic acid.

3. The aqueous zinc battery of claim 2, wherein the organic acid having two carboxylic acid groups includes glutaric acid.

4. The aqueous zinc battery of claim 1, wherein a pH of the electrolyte solution is less than 5.6.

5. The aqueous zinc battery of claim 1, wherein the aqueous zinc battery forms a protective layer on a surface of the negative electrode.

6. The aqueous zinc battery of claim 5, wherein a thickness of the protective layer is 0.001 to 500 nm.

7. The aqueous zinc battery of claim 5, wherein the protective layer is a zinc glutarate protective layer.

8. The aqueous zinc battery of claim 1, wherein the zinc salt includes at least one selected from the group consisting of zinc sulfate, zinc triflate, zinc acetate, zinc butyrate, zinc glycerate, zinc gluconate, zinc glycolate, zinc formate, zinc lactate, zinc picolinate, zinc propionate, zinc salicylate, zinc tartrate, and zinc undecylenate.

9. The aqueous zinc battery of claim 1, wherein the zinc salt includes at least one selected from the group consisting of zinc sulfate and zinc triflate.

10. The aqueous zinc battery of claim 1, wherein the positive electrode includes at least one selected from the group consisting of carbon nanotubes, carbon fiber, fullerene, graphite, graphene, carbon black, carbon felt, carbon paper, and ketjen black.

11. The aqueous zinc battery of claim 1,
wherein the negative electrode is in contact with the electrolyte solution,
the positive electrode is in contact with a solution including at least one selected from the group consisting of KI, KBr, and KCl, and
the battery is for a redox flow battery.

12. The aqueous zinc battery of claim 1, wherein a concentration ratio of the organic acid having two carboxylic acid groups to the zinc salt is 0.001:1 to 1:1.

13. An electrolyte solution for an aqueous zinc battery comprising:
a zinc salt; and
an organic acid having two carboxylic acid groups,
wherein the organic acid having two carboxylic acid groups has 2 to 4 carbon atoms between the two carboxylic acid groups.

14. The electrolyte solution for an aqueous zinc battery of claim 13, wherein the organic acid having two carboxylic acid groups includes at least one selected from the group consisting of glutaric acid, succinic acid, and adipic acid.

15. The electrolyte solution for an aqueous zinc battery of claim 14, wherein the organic acid having two carboxylic acid groups includes glutaric acid.

16. An aqueous zinc battery comprising:
a negative electrode including zinc
a zinc organic acid salt protective layer disposed on a surface of the negative electrode;
a positive electrode disposed to be opposite to the negative electrode; and
an electrolyte solution including a zinc salt,
wherein an organic acid of the zinc organic acid salt includes two carboxylic acid groups and has 2 to 4 carbon atoms between the two carboxylic acid groups.

17. The aqueous zinc battery of claim 16, wherein the zinc organic acid salt protective layer is a zinc glutarate protective layer.

18. The aqueous zinc battery of claim 16, wherein the electrolyte solution further includes an organic acid having two carboxylic acid groups.
